(19) United States
(12) Patent Application Publication
(10) Pub. No.: US 2025/0240759 A1
(43) Pub. Date: Jul. 24, 2025

(54) METHODS, SYSTEM, AND APPARATUS FOR TERRESTRIAL AND NON-TERRESTRIAL POSITIONING

(71) Applicant: Huawei Technologies Co., Ltd., Shenzen (CN)

(72) Inventors: Aman Jassal, Stittsville (CA); Amine Maaref, Ottawa (CA); Jianglei Ma, Ottawa (CA)

(21) Appl. No.: 19/083,169

(22) Filed: Mar. 18, 2025

Related U.S. Application Data
(63) Continuation of application No. PCT/CN2022/120870, filed on Sep. 23, 2022.

(51) Int. Cl. H04W 64/00; H04L 5/00; H04W 24/08

(52) U.S. Cl. CPC H04W 64/00; H04L 5/0051; H04W 24/08

(57) ABSTRACT

Aspects of the present application relate to removing the separateness and independence of positioning practices implemented for terrestrial networks and the positioning practices implemented for non-terrestrial networks. In part, a new framework of user equipment (UE) machine states is introduced. Each of the UE power modes may be associated with specific functions. A UE and a transmit receive point (TRP) may engage in handshaking that includes the UE transmitting a request to change from a first UE power mode to a second UE power mode. Responsive to the request, the UE may receive, from the TRP, a response. The response may include information to allow the UE to perform one or more functions associated with the second UE power mode. Among the UE power modes may be a low power mode, wherein the UE carries out functions limited to little more than positioning.

### CROSS-REFERENCE TO RELATED APPLICATION

This application is a continuation of International Application No. PCT/CN2022/120870, filed on Sep. 23, 2022, all the contents of which are hereby incorporated by reference in its entirety.

### TECHNICAL FIELD

The present disclosure relates, generally, to wireless communication in terrestrial and non-terrestrial networks and, in particular embodiments, to measuring positioning reference signals within such networks.

### BACKGROUND

Wireless communication systems allow electronic devices, also known as user equipment (UE), to transmit and receive to and from larger communication networks via transmit and receive points (TRPs). Certain UEs may be implemented as embedded systems. It is known that, sometimes, an embedded system may have limited battery capacity, limited storage space, and limited analog beamforming capability. For UEs that support current radio access technologies, such as the technology known as fifth generation (5G) new radio (NR), support for millimeter wavelength (mmWave) frequency bands may be considered to be especially challenging for those situations wherein the UE may be required to support multiple receiver (Rx) beamformers. Low-end UEs, which inherently have low complexity, may have only a single Rx beamformer. Detecting and/or demodulating different reference signals may be accomplished by implementing, at the UE, different spatial Rx filters. The implementation of different spatial Rx filters may not always be practical for low-end UEs.

In current 5G NR systems, positioning methods are known to rely on approaches that employ a measurement of an Observed Time Difference of Arrival (OTDOA). In an OTDOA approach to positioning, the UE measures a time difference of arrival of certain reference signals, which have been transmitted by a TRP, relative to a time difference of arrival of a baseline reference signal, which has been transmitted by the same TRP. The quality of a link from the TRP to the UE may be shown to affect the quality of the measurements of the OTDOA. It follows that a drop in the link quality for one reference signal, which has been transmitted by one TRP, adversely affects the extent to which the UE may accurately determine positioning. Accordingly, the drop in the link quality may be considered to impact positioning information integrity.

Global navigation satellite systems (GNSSs) such as the known Global Positioning System (GPS), Galileo and Beidou are based on code division multiple access (CDMA) signals. In contrast, the known Global'naya Navigatsionnaya Sputnikovaya Sistema (GLONASS) is based on frequency division multiple access (FDMA) signals. All GNSS systems rely on the use of pseudorandom noise (PRN) sequences which are then modulated using CDMA/FDMA. In GNSSs, positioning methods may be shown to rely upon an approach that uses measurement of Time of Arrival (TOA). GNSS signals are known to carry information indicating a transmission time. GNSS receivers detect and demodulate GNSS signals from at least four satellites to, thereby, obtain an accurate positioning estimate.

### SUMMARY

Aspects of the present application relate to removing the separateness and independence of positioning practices implemented for terrestrial networks and the positioning practices implemented for non-terrestrial networks. In part, a new framework of UE machine states is introduced. The new framework may be based on so-called “UE power modes.” Each of the UE power modes may be associated with specific functions. A UE and a TRP may engage in handshaking that includes the UE transmitting a request to change from a first UE power mode to a second UE power mode. Responsive to the request, the UE may receive, from the TRP, a response. The response may include information to allow the UE to perform one or more functions associated with the second UE power mode. Among the UE power modes may be a low power mode, wherein the UE carries out functions limited to little more than positioning.

It has been recognized that attention has recently been paid to integrating terrestrial networks for mobile communication with non-terrestrial networks for mobile communication. Unfortunately, each of these types of networks has distinct practices for obtaining and using positioning measurements. It has also been recognized that, even when the distinct practices for obtaining and using positioning measurements have been integrated, there will be call for some sort of prioritization mechanism to allow a UE to figure out which type of positioning measurement to employ in different scenarios.

Aspects of the present application relate to a framework of UE power modes. The framework may be shown to allow a UE to initiate positioning measurements on the basis of the UE power mode in which the UE is operating. Through the use of a positioning accuracy monitoring procedure, the UE may react to a change in the radio environment by causing a change to occur in the UE power mode in which the UE is operating. The change in the UE power mode may correspond to a change in type of positioning measurement.

According to an aspect of the present disclosure, there is provided a method. The method includes transmitting, at a device operating in a first mode of a positioning-based device state machine, a request to transition to a second mode of the positioning-based device state machine and receiving, at the device, a response to the request, the response including information to allow the device to perform a function associated with the second mode.

According to an aspect of the present disclosure, there is provided a device. The device includes a memory storing instructions and a processor. The processor is caused, by executing the instructions to transmit, while operating in a first mode of a positioning-based device state machine, a request to transition to a second mode of the positioning-based device state machine and receive a response to the request, the response including information to allow the device to perform a function associated with the second mode.

According to an aspect of the present disclosure, there is provided a method of positioning accuracy monitoring. The method includes detecting, while measuring terrestrial positioning reference signals, a positioning failure instance, determining that the positioning failure instance has caused a count of positioning failure instances, for a given time unit, to exceed a failure instance threshold and, responsive to the determining, commencing measuring non-terrestrial positioning reference signals.

According to an aspect of the present disclosure, there is provided a method for switching, at a device, a type of positioning reference signals measured. The method includes operating in a first power mode, the first power mode allowing the device to measure terrestrial positioning reference signals, receiving a command and, responsive to the receiving the command, commencing operating in a second power mode, the second power mode disallowing measurement of terrestrial positioning reference signals and allowing the device to measure non-terrestrial positioning reference signals.

According to an aspect of the present disclosure, there is provided an apparatus. The apparatus includes a memory storing instructions and a processor. The processor is caused, by executing the instructions, to detect, while measuring terrestrial positioning reference signals, a positioning failure instance, determine that the positioning failure instance has caused a count of positioning failure instances, for a given time unit, to exceed a failure instance threshold and commence, responsive to the determining, measuring non-terrestrial positioning reference signals.

According to an aspect of the present disclosure, there is provided a device. The device includes a memory storing instructions and a processor. The processor is caused, by executing the instructions, to detect, while measuring terrestrial positioning reference signals, a positioning failure instance, determine that the positioning failure instance has caused a count of positioning failure instances, for a given time unit, to exceed a failure instance threshold and commence, responsive to the determining, measuring non-terrestrial positioning reference signals.

According to an aspect of the present disclosure, there is provided a method. The method includes measuring positioning reference signals, detecting a beam failure, determining that positioning reference signals are to be measured on a same symbol on which beam failure recovery reference signals are to be measured and, responsive to the detecting, prioritizing measuring the beam failure recovery reference signals.

According to an aspect of the present disclosure, there is provided a device. The device includes a memory storing instructions and a processor. The processor is caused, by executing the instructions, to measure positioning reference signals, detect a beam failure, determine that positioning reference signals are to be measured on a same symbol on which beam failure recovery reference signals are to be measured and prioritizing, responsive to the determining, measuring the beam failure recovery reference signals.

In another aspect, an apparatus is provided. The apparatus comprises a processor configured to cause the apparatus to perform any of the preceding methods.

In another aspect, a non-transitory computer readable medium is provided. The non-transitory computer readable medium has machine-executable instructions stored thereon, wherein the instructions, when executed by a processing unit of an apparatus, cause the apparatus to perform any of the preceding methods.

In another aspect, a computer program product is provided. The computer program product comprises instructions which, when the program is executed by a computer, cause the computer to perform any of the preceding methods.

In another aspect, a processor of an apparatus is provided. The processor is configured to cause the apparatus to perform any of the preceding methods.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a known UE state machine;

FIG. 7 illustrates an example of a framework of UE machine states based on three UE power modes, according to aspects of the present application;

FIG. 8 illustrates an example of a timeline in which a UE switches between positioning reference signals transmitted by terrestrial transmit receive points and positioning reference signals transmitted by non-terrestrial transmit receive points, according to aspects of the present application;

FIG. 9 illustrates a positioning-based UE state machine, according to aspects of the present application;

FIG. 10 illustrates an example link establishment request template, according to aspects of the present application;

FIG. 11 illustrates an example link establishment response template, according to aspects of the present application;

FIG. 12 illustrates an example link establishment request, according to aspects of the present application;

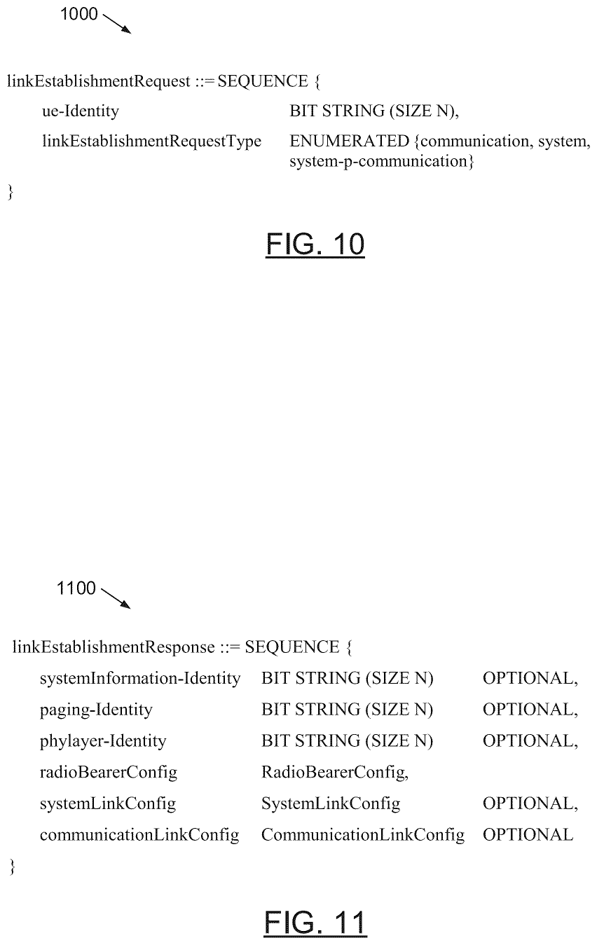

FIG. 10 illustrates an example link establishment response, according to aspects of the present application;

FIG. 14 illustrates an example link establishment request, according to aspects of the present application;

FIG. 15 illustrates an example link establishment response, according to aspects of the present application;

FIG. 16 illustrates an example link establishment request, according to aspects of the present application;

FIG. 17 illustrates an example link establishment response, according to aspects of the present application;

FIG. 18 illustrates an example of a framework of UE machine states based on six UE power modes, according to aspects of the present application;

FIG. 19 illustrates an example of a System Information Block message template, according to aspects of the present application;

FIG. 20 illustrates an example radio resource control signaling message template, according to aspects of the present application;

FIG. 21 illustrates an example link establishment request template, according to aspects of the present application;

FIG. 22 illustrates an example link establishment response template, according to aspects of the present application;

FIG. 23 illustrates an example link release command template, according to aspects of the present application;

FIG. 24 illustrates an alternative example link release command template, according to aspects of the present application;

FIG. 25 illustrates the UE power modes of FIG. 18, in addition to arrows representative of various possible transitions between the UE power modes, according to aspects of the present application;

FIG. 26 illustrates an example of a timeline in which a UE switches between positioning reference signals transmitted by terrestrial transmit receive points and positioning reference signals transmitted by non-terrestrial transmit receive points, according to aspects of the present application; and

FIG. 27 illustrates an example of a timeline in which a UE prioritizes reference signals, according to aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

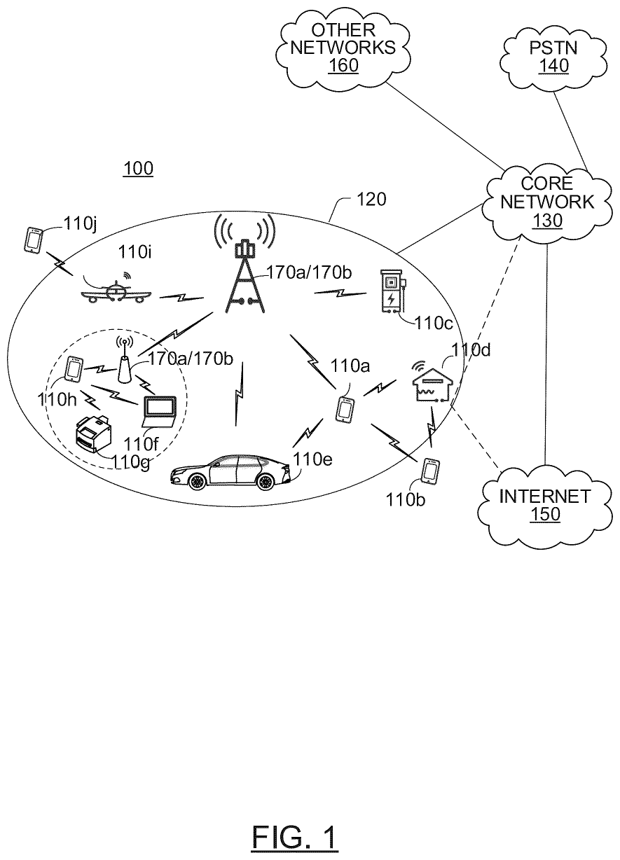

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

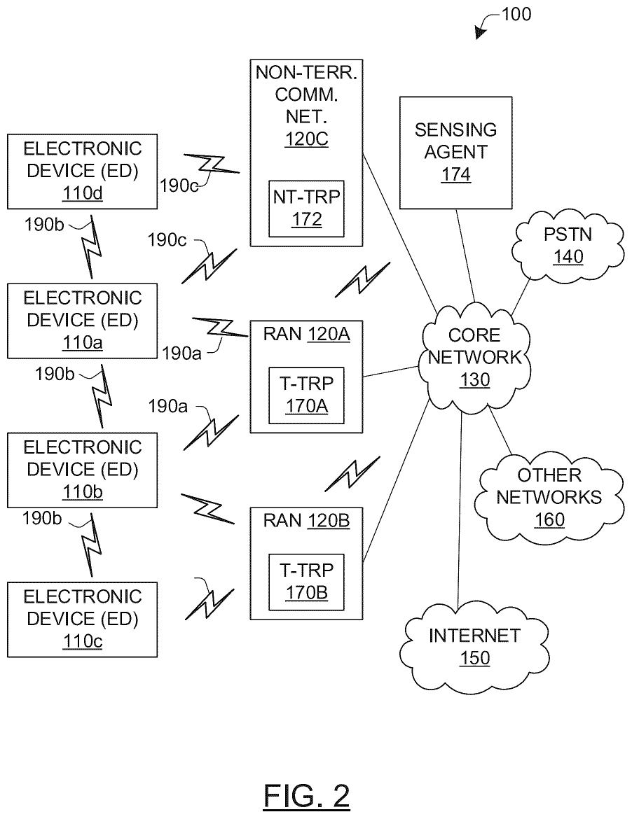

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

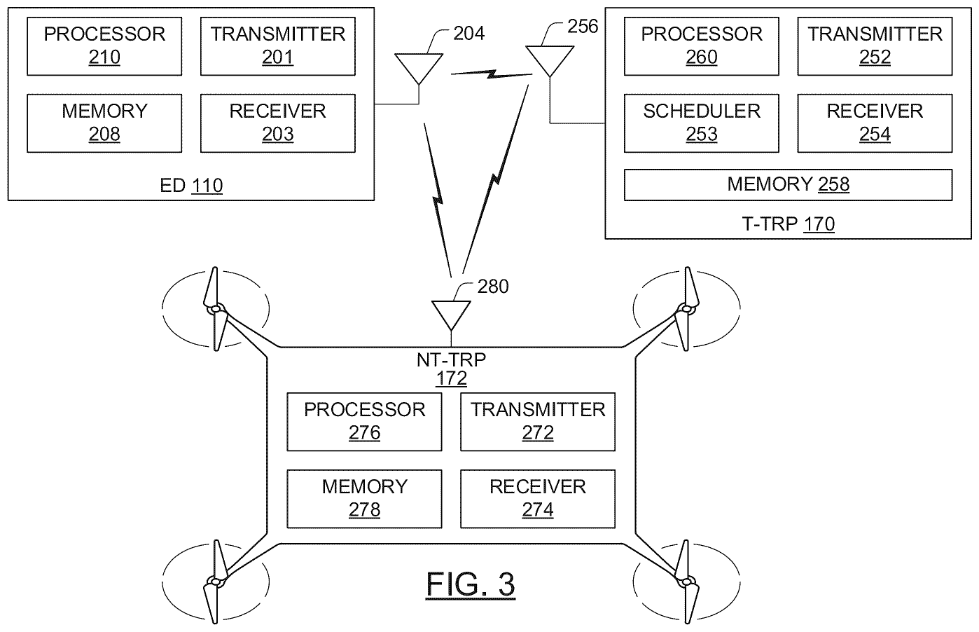

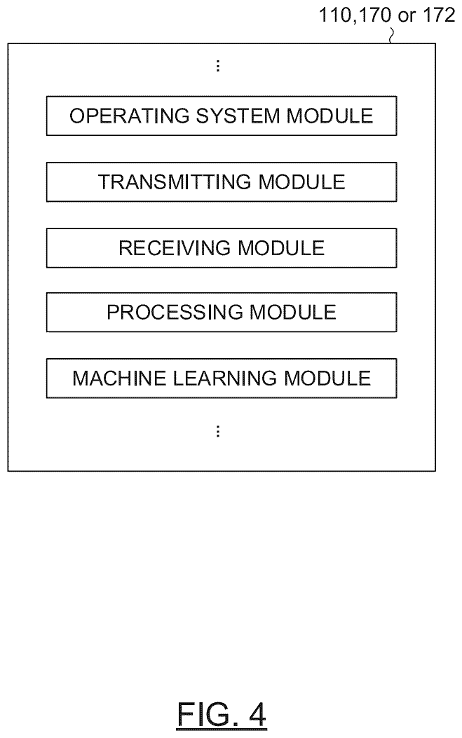

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE).

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

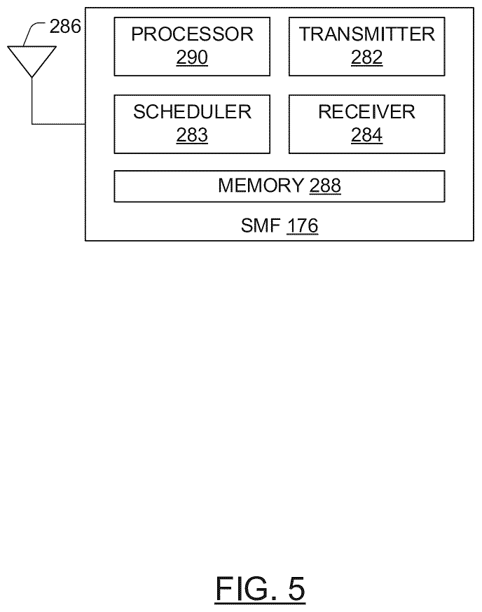

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas is arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

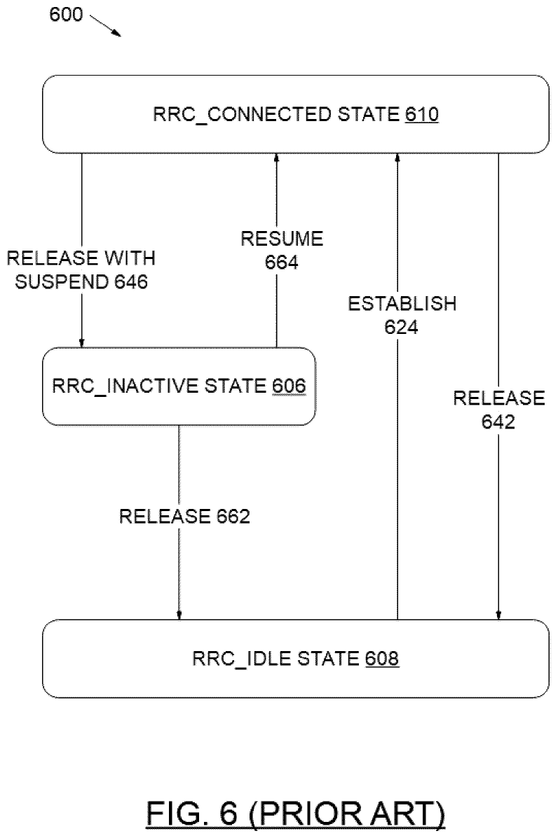

An ED 110 can operate in a variety of modes in order to trade off certain features for more or less device power consumption and/or network resource consumption. In 3GPP New Radio (NR), each UE may operate in one of several modes known as Radio Resource Control (RRC) states. Accordingly, a UE (such as the ED 110) may operate in one of the following three RRC states, illustrated in FIG. 6: an RRC_IDLE state 608; an RRC_CONNECTED state 610; and an RRC_INACTIVE state 606. In other documentation, these states may be referenced as “modes”, for example, “RRC_IDLE mode.” When the ED 110 is in the RRC_CONNECTED state 610, the ED 110 may be considered to have been connected to the network as a result of a connection establishment procedure 624. When the ED 110 has transitioned to the RRC_IDLE state 608, for example by way of a release procedure 642 or by way of a release procedure 662, the ED 110 is not connected to the network, but the network knows that the ED 110 is present in the network. By switching to the RRC_INACTIVE state 606 by way of a release with suspend procedure 646, the ED 110 helps conserve network resources and local power (thereby lengthening, for example, perceived battery life of the ED 110). The RRC_INACTIVE state 606 may be useful, for example, in those instances when the ED 110 is not communicating with the network. When an ED 110 is in the RRC_INACTIVE state 606, the ED 110 is also helping to conserve network resources and local power. However, when the ED 110 is in the RRC_INACTIVE state 606, the network and the ED 110 both store at least some configuration information to, thereby, allow the ED 110 to reconnect to the network, by way of a resume procedure 664, more rapidly than the ED 110 would be able to reconnect, by way of the connection establishment procedure 624, in the case wherein the ED 110 is in the RRC_IDLE state 608. The storage of at least some configuration information when the ED 110 is in the RRC_INACTIVE state 606 is one aspect that distinguishes the RRC_INACTIVE state 606 from the RRC_IDLE state 608. Notably, the acronym RRC is a reference to the known Radio Resource Control protocol.

FIG. 6 illustrates a known UE state machine 600. In particular, FIG. 6 illustrates that the known UE state machine 600 includes the RRC_CONNECTED state 610, the RRC_IDLE state 608, and the RRC_INACTIVE state 606. The release procedure 642 may involve the T-TRP 170 transmitting a higher-layer signaling message (i.e., an RRC message) to the UE 110.

While the UE 110 is in the RRC_IDLE state 608, it is expected that the UE 110 will monitor short messages, monitor paging messages, perform neighbor cell measurements and acquire system information.

While the UE 110 is in the RRC_INACTIVE state 606, the UE 110 additionally performs RAN-based notification area updates periodically when moving outside a RAN-based notification area.

While the UE 110 is in RRC_CONNECTED state 610, the UE 110 additionally monitors control channels associated with a shared data channel. Such monitoring allows the UE 110 to determine whether data is scheduled for the UE 110, allows the UE 110 to determine channel quality, allows the UE 110 to receive feedback information and allows the UE 110 to perform neighbor cell measurement and reporting.

Although much of the communication, described hereinbefore, related to the UE 110 determining positioning in the context of communication with a T-TRP 170, much of the communication applies similarly in the context of communication with an NT-TRP 172.

Unfortunately, the positioning practices implemented for terrestrial networks (e.g., 5G NR positioning) and the positioning practices implemented for non-terrestrial networks (e.g., GNSS positioning) may be considered to be separate and independent.

Aspects of the present application relate to integrating positioning measurements in a joint terrestrial/non-terrestrial system to, thereby, derive synergistic benefits. According to some aspects of the present application, the integration of the positioning measurements may be based on a framework of so-called UE power modes. According to other aspects of the present application, prioritization mechanisms are defined so that the UE 110 may determine the reference signals, measurements of which are to be prioritized. The prioritization mechanisms may, for example, have some dependence on UE power modes and changes in the environment. Additionally, aspects of the present application relate to UE-initiated reference signal measurement switching. The switching may be based upon a positioning accuracy monitoring procedure.

T-TRPs 170 and NT-TRPs are known to transmit reference signals (RSs) for a variety of functions. The functions include: position determination; mobility determination; radio link monitoring (RLM); beam management (BM); and channel state information (CSI) determination. Reference signals may be implemented using binary pseudorandom noise (PRN) sequences. The PRN sequences may be mapped onto a time/frequency resource grid using some mapping function. Example sequences that may be used for generating the PRN sequences include: maximal-length sequences; Gold sequences; Kasami sequences; and Barker sequences. One simple way for the UE 110 to distinguish reference signals transmitted (e.g., for position determination) by T-TRPs 170 from reference signals transmitted by NT-TRPs 172 is on the basis of the length of the PRN sequences. That is, the T-TRPs 170 may use a sequence length of Nₜₑᵣᵣₑₛₜᵣᵢₐₗ (≥1) and the NT-TRPs 172 may use a sequence length of Nₙₒₙ₋ₜₑᵣᵣₑₛₜᵣᵢₐₗ (≥1), where Nₜₑᵣᵣₑₛₜᵣᵢₐₗ and Nₙₒₙ₋ₜₑᵣᵣₑₛₜᵣᵢₐₗ are different.

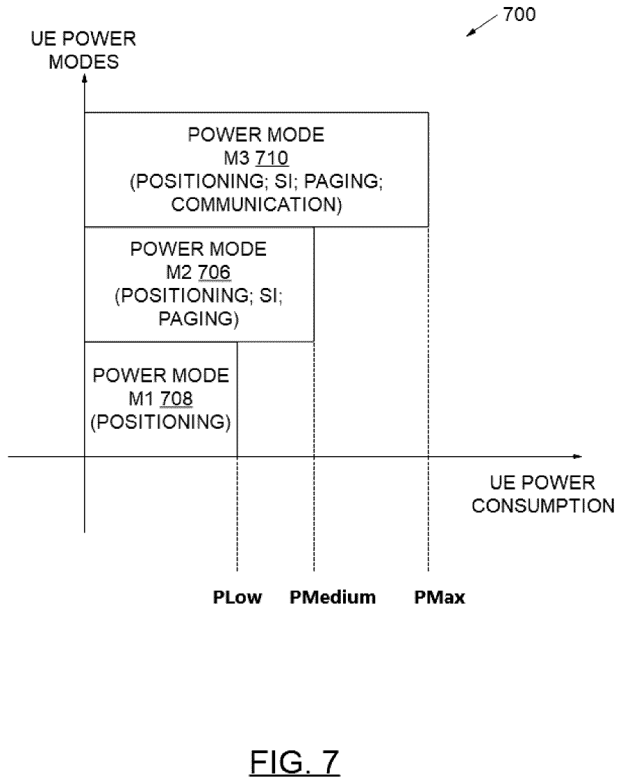

Aspects of the present application relate to defining a new framework of UE machine states. The new framework may be based on so-called “UE power modes.” Each UE power mode may be defined by combining a function with an upper-bound and a lower-bound for power consumption. Examples of functions that the UE 110 may run include: position determination; system information acquisition; paging; and communication. FIG. 7 illustrates an example of a framework 700 of UE machine states based on three UE power modes. In the context of the present application, a UE machine state can be understood to be an implementation of a UE power mode where each UE machine state is associated to a given UE power mode with corresponding upper and lower power consumption bounds.

The framework 700 of UE machine states is illustrated in FIG. 7 to include three UE machine states: a first UE power mode (denoted as M1) 708; a second UE power mode (denoted as M2) 706; and a third UE power mode (denoted as M3) 710.

The first UE power mode 708 may be considered to represent a low power consumption mode. The first UE power mode 708 is illustrated, in FIG. 7, as being lower-bounded by P=0 and upper-bounded by P=P_{Low}. The first UE power mode 708 is associated with the function of positioning. When the UE 110 is in the first UE power mode 708, the UE 110 performs positioning measurements based on positioning reference signals transmitted by either T-TRPs 170 or NT-TRPs 172. Positioning reference signals are based on pseudorandom noise (PRN) sequences which are then mapped on time-frequency resources.

The second UE power mode 706 may be considered to represent a medium power consumption mode. The second UE power mode 706 is illustrated, in FIG. 7, as being lower-bounded by P_{Low} and upper-bounded by P_{Medium}. The second UE power mode 706 is associated with the functions of positioning, system information (SI) acquisition and paging. When the UE 110 is in the second UE power mode 706, the UE 110 performs positioning measurements based on positioning reference signals transmitted by either T-TRPs 170 or NT-TRPs 172. The UE 110 also performs SI acquisition and monitors for paging messages on a paging channel.

The third UE power mode 710 may be considered to represent a high power consumption mode. The third UE power mode 710 is illustrated, in FIG. 7, as being lower-bounded by P_{Medium} and upper-bounded by P_{Max}. The third UE power mode 710 is associated with the functions of Positioning, SI acquisition and Paging and Communication. When the UE 110 is in the third UE power mode 710, the UE 110 performs positioning measurements based on positioning reference signals transmitted by either T-TRPs 170 or NT-TRPs 172. The UE 110 also performs SI acquisition and monitors for paging messages on a paging channel. The UE 110 also performs functions related to communication. Such functions may, for instance, include: monitoring control channels associated with data channels to determine whether data is to be received and/or transmitted; providing feedback information regarding channel quality; and providing feedback information regarding beam quality.

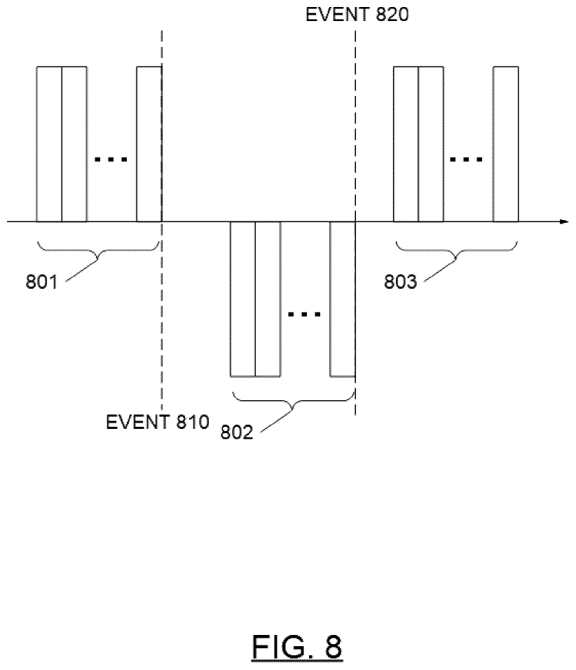

As has been mentioned hereinbefore, the UE 110 may perform positioning measurements based on reference signals (RSS). Reference signals are typically based on PRN sequences. PRN sequences may be generated using so-called Linear Feedback Shift Registers (LFSRs). The PRN sequences may, after generation, be mapped to the time-frequency grid. The UE 110 attempts to detect and measure RSs for all kinds of purposes, such as positioning, mobility management, radio link monitoring, BM, CSI and traffic data reception. In the context of aspects of the present application, it may be assumed that T-TRPs 170 and NT-TRPs 172 both use positioning RSs that are based upon PRN sequences of differing lengths. For instance, T-TRPs 170 may use PRN sequences of length NTN and NT-TRPs 172 may use PRN sequences of length NNTN. FIG. 8 illustrates an example of a timeline in which a UE 110 switches between positioning RSs transmitted by T-TRPs 170 and positioning RSs transmitted by NT-TRPs 172.

The UE 110 that is the subject of the timeline of FIG. 8 may be assumed to have been configured to recognize positioning RSs transmitted by terrestrial TRPs (hereinafter “terrestrial positioning RSs”) and to have been configured to recognize positioning RSs transmitted by non-terrestrial TRPs (hereinafter “non-terrestrial positioning RSs”).

The UE 110 is configured to detect and measure reference signals, in addition to being configured to detect and decode physical layer channels. Occasionally, a change may occur in the radio environment in which the UE 110 is operating. For example, the UE 110 may pass from an urban area into a rural area. It is well known that the radio environment in an urban area is distinct from the radio environment in a rural area. To determine that a change has occurred in the radio environment, the UE 110 may execute a so-called “Positioning Accuracy Monitoring” (PAM) procedure.

In the timeline illustrated in FIG. 8, the UE 110 initially operates in a first phase 801, wherein the UE 110 performs positioning based upon terrestrial positioning RSs. Subsequent to a first event 810, wherein a change occurs in the radio environment as the UE 110 moves from an urban area to a rural area, the UE 110 autonomously switches to a second phase 802, wherein the UE 110 performs positioning based upon measuring non-terrestrial positioning RSs. Subsequent to a second event 820, wherein a change occurs in the radio environment as the UE 110 moves from a rural area to an urban area, the UE 110 autonomously switches to a third phase 803, wherein the UE 110 returns to performing positioning based upon measuring terrestrial positioning RSs.

According to the PAM procedure, the UE 110 may monitor for events (such as the first event 810 and the second event 820 of FIG. 8) to determine whether to perform positioning measurements using terrestrial positioning RSs or to perform positioning measurements using non-terrestrial positioning RSs. An example event for which the UE 110 may monitor is a “Positioning Failure” instance. An instance may be defined as a measurement interval defined for a given time unit. A time unit may, for some examples, be an OFDM symbol, a group of OFDM symbols, a chip, a group of chips, a mini-slot, a group of mini-slots, a slot or a frame. Measurements performed by the UE 110 can, for a few examples, be reference signal received power (RSRP), reference signal received quality (RSRQ), signal-to-interference-and-noise ratio (SINR) or reference signal time difference (RSTD). Thresholds for Positioning Failure can be defined using rules based on, for a few examples RSRP threshold, RSRQ threshold, SINR threshold, RSTD threshold, positioning accuracy or residual error difference between RSTD measurements.

According to the PAM procedure, the UE 110 may monitor Positioning Failure instances and, based on the results of the monitoring, the UE 110 may autonomously transition from measuring reference signals from one network (e.g., terrestrial positioning RSs) to measuring reference signals from another network (e.g., terrestrial positioning RSs).

An integer threshold, N₁ (N₁≥1), may be defined so that, responsive to the UE 110 detecting N₁ consecutive Positioning Failure instances based on measuring terrestrial positioning RSs, the UE 110 autonomously switches to measuring non-terrestrial positioning RSs. A Positioning Failure instance may be defined as measurement results remaining below a defined threshold.

While the UE 110 is performing positioning based on the non-terrestrial positioning RSs, the UE 110 may continue to monitor terrestrial positioning RSs. A Positioning Recovery instance may be defined in a manner that is similar to the manner in which Positioning Failure instance have been defined. A Positioning Recovery instance may be defined as measurement results remaining above a defined threshold.

An integer threshold, N₂ (N₂≥1), may be defined such that, responsive to the UE 110 detecting N₂ consecutive Positioning Recovery instances based on measuring terrestrial positioning RSs, the UE 110 autonomously switches to measuring only terrestrial positioning RSs. That is, the UE 110 was measuring terrestrial positioning RSs while the UE 110 was measuring non-terrestrial positioning RSs. The autonomous switch represents a switch between measuring both terrestrial positioning RSs and non-terrestrial positioning RSs to measuring only terrestrial positioning RSs.

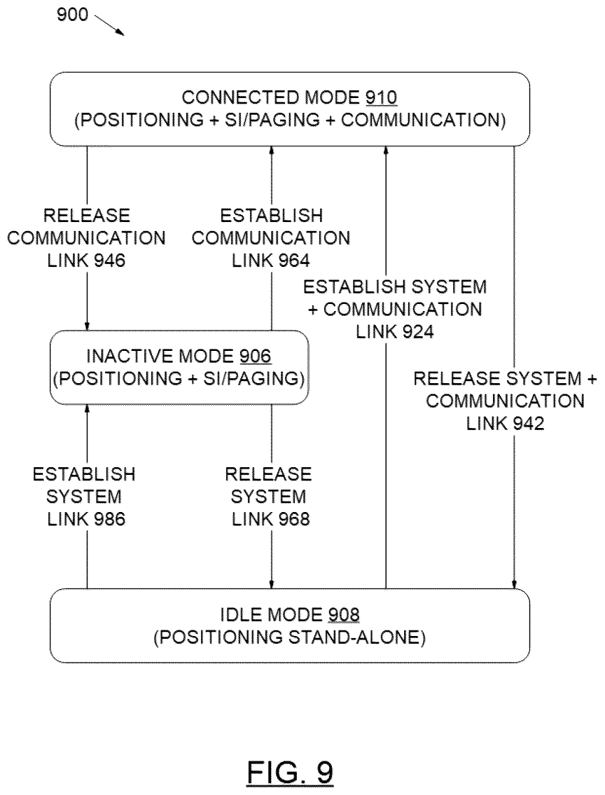

Aspects of the present application relate to a positioning-based UE state machine 900, illustrated in FIG. 9. The positioning-based UE state machine 900 of FIG. 9 is defined based on three states. In particular, FIG. 9 illustrates that the positioning-based UE state machine 900 includes an idle mode 908 (also called a positioning stand-alone state), an inactive mode 906 (also called a positioning+SI/paging state) and a connected mode 910 (also called a positioning+SI/paging+communication state).

The idle mode 908 (the positioning stand-alone state) may be the first state into which the UE 110 goes after being powered on. In the idle mode 908, the UE 110 may be considered to be able to operate at a low UE power consumption level. The UE 110 may be configured to only measure non-terrestrial positioning RSs, as the non-terrestrial positioning RSs allow the UE 110 to perform positioning measurements without having to rely on beam sweeping, due to the UE 110 having a priori information regarding expected angles of arrival for the non-terrestrial positioning RSs. It may be assumed that, in the idle mode 908, the UE 110 has no identity assigned to it by a TRP 170/172.

The UE 110 may enter into the inactive mode 906 (the positioning+SI/paging state) from the idle mode 908 (the positioning stand-alone state) or from the connected mode 910 (the positioning+SI/paging+communication state). In the inactive mode 906 (the positioning+SI/paging state), the UE 110 may be configured to operate at medium UE power consumption levels. The UE 110 may make a selection between measuring terrestrial positioning RSs and measuring non-terrestrial positioning RSs, with the selection based on services that have been requested, radio conditions that have been experienced and ongoing power consumption at the UE 110. It may be assumed that, in the inactive mode 906 (the positioning+SI/paging state), the UE 110 has an identity (e.g., a UE-specific identity or a group-specific identity), the identity allowing the UE 110 to monitor SI messages and paging messages.

The UE 110 may enter into the connected mode 910 (the positioning+SI/paging+communication state) from the idle mode 908 (the positioning stand-alone state) or from the inactive mode 906 (the positioning+SI/paging state). In the connected mode 910, the UE 110 may be configured to operate at up to a maximum UE power consumption, and since the UE is performing all types of functions, including Communication-related functions. The UE 110 may make a selection between measuring terrestrial positioning RSs and measuring non-terrestrial positioning RSs, with the selection based on services that have been requested, radio conditions that have been experienced and ongoing power consumption at the UE 110. It may be assumed that, in the connected mode 910 (the positioning+SI/paging+communication state), the UE 110 has an identity (e.g., a UE-specific identity or a group-specific identity), the identity allowing the UE 110 to monitor SI messages, paging messages and communication messages.

In view of FIG. 9, it is notable that the UE 110 may transition between the different modes 906/908/910 through the use of higher-layer signaling (e.g., RRC signaling). To transition from the idle mode 908 to the inactive mode 906, the UE 110 may transmit establish system link signaling 986. To transition from the inactive mode 906 to the idle mode 908, the UE 110 may transmit release system link signaling 968. To transition from the idle mode 908 to the connected mode 910, the UE 110 may transmit establish system+communication link signaling 924. To transition from the connected mode 910 to the idle mode 908, the UE 110 may transmit release system+communication link signaling 942. To transition from the inactive mode 906 to the connected mode 910, the UE 110 may transmit establish communication link signaling 964. To transition from the connected mode 910 to the inactive mode 906, the UE 110 may transmit release communication link signaling 946.

For the signaling 986/968/924/942/964/946 related to each of the mode transitions, one of many hand-shaking procedures may take place between the UE 110 and the TRP 170/172. According to one hand-shaking procedure, the UE 110 may transmit a link establishment request to the TRP 170/172. An example link establishment request template 1000 is illustrated in FIG. 10. Responsive to receiving a link establishment request, the TRP 170/172 may transmit a link establishment response. An example link establishment response template 1100 is illustrated in FIG. 11. The link establishment response may, as illustrated in FIG. 11, include information to allow the UE 110 to perform the functions associated with the state into which the UE 110 is to transition. That is, subsequent to the exchange of a link establishment request and a link establishment response, the UE 110 may be understood to have carried out a mode transition from the idle mode 908 to the connected mode 910.

It should be evident that the modes 906/908/910 illustrated in FIG. 9 correspond closely to the RRC states 606/608/610 illustrated in FIG. 6. Notably, while there is no structure in place for a transition from the RRC_IDLE state 608 to the RRC_INACTIVE state 606, according to aspects of the present application, establish system link signaling 986 is contemplated to allow the UE 110 to carry out a mode transition from the idle mode 908 to the inactive mode 906. It should be evident that the modes 906/908/910 illustrated in FIG. 9 also correspond closely to the UE power modes 706/708/710 illustrated in FIG. 7.

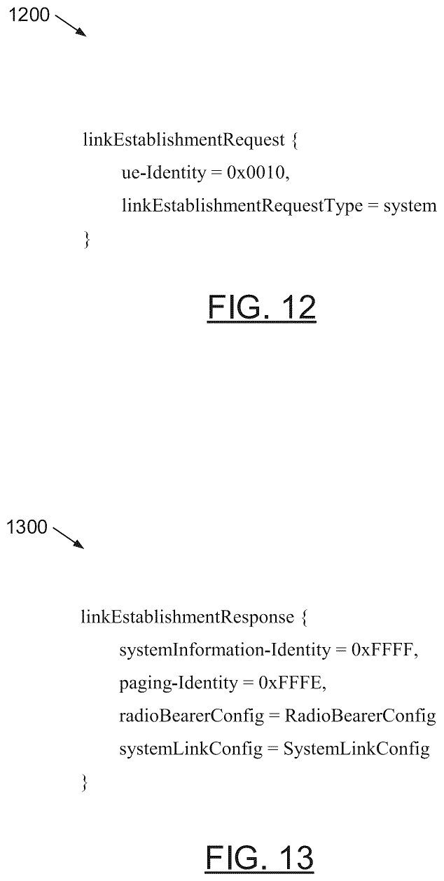

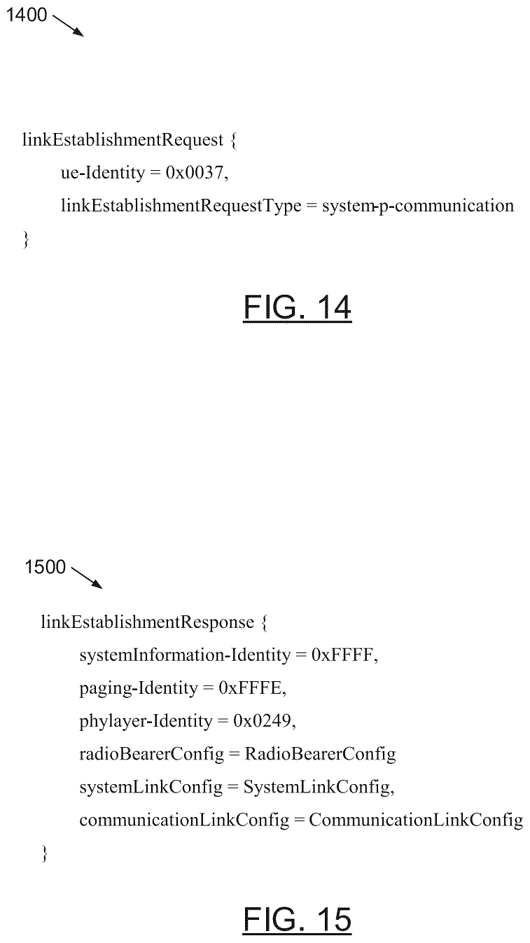

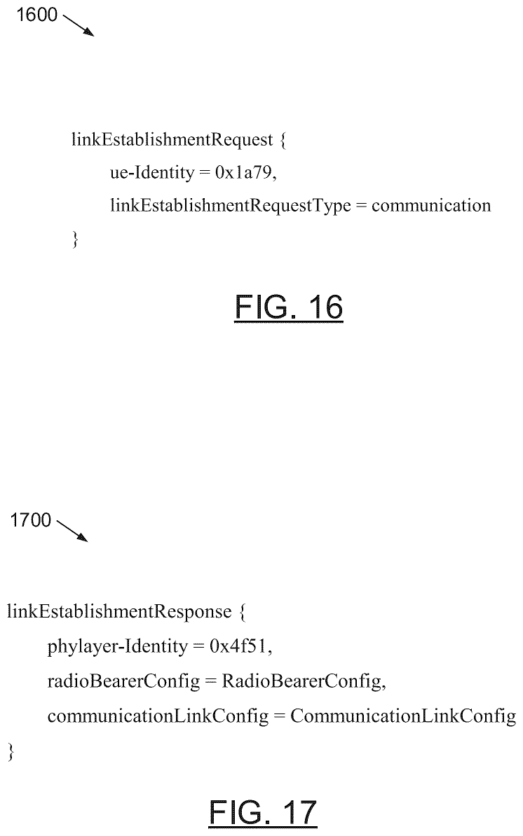

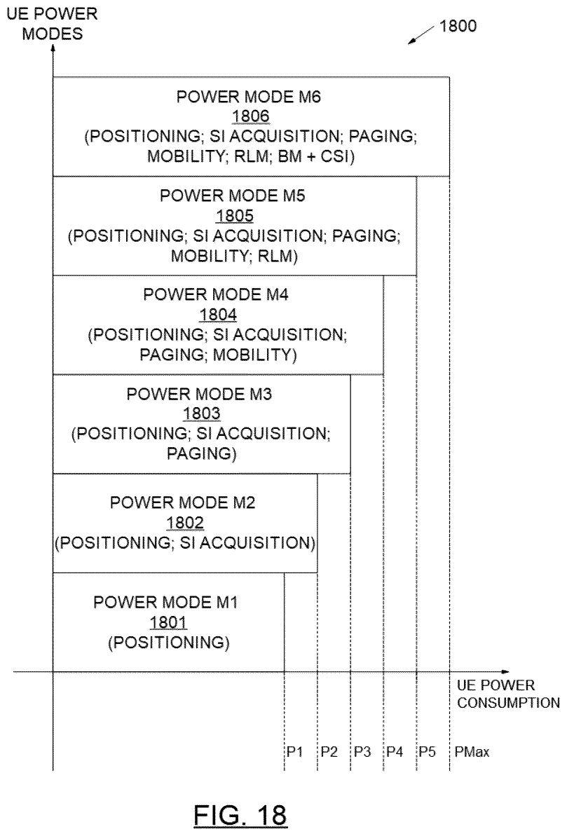

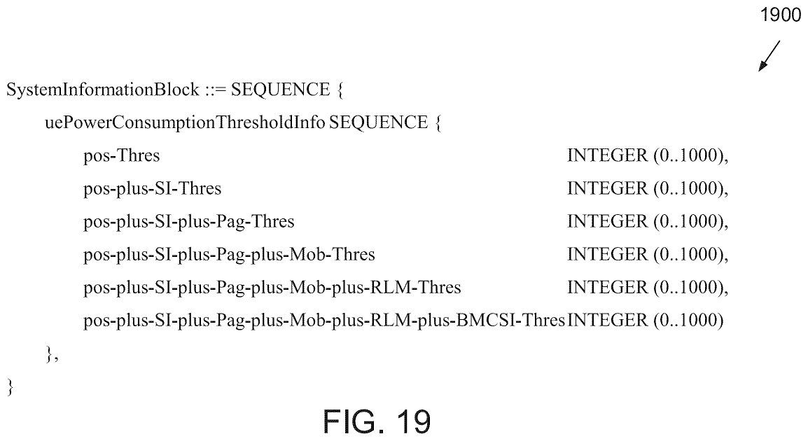

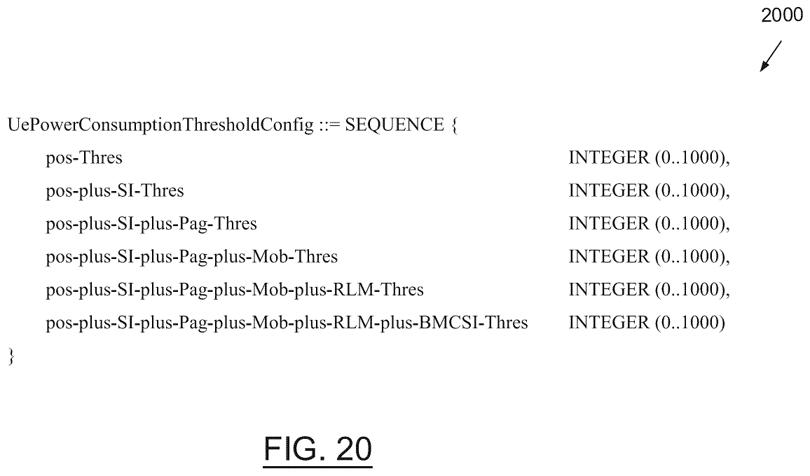

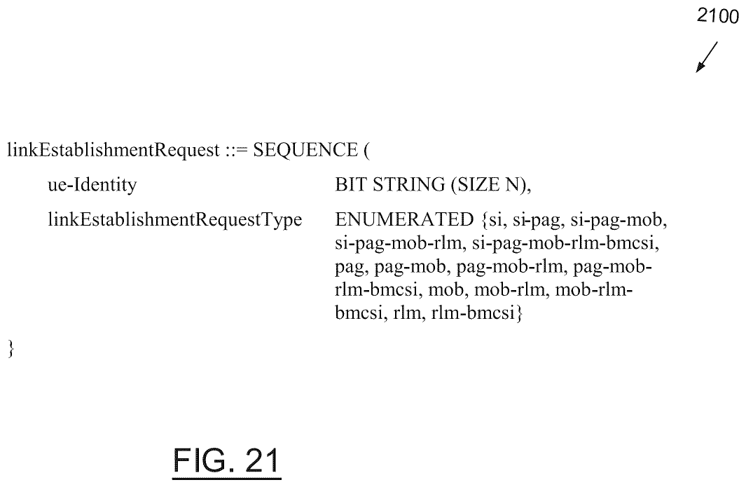

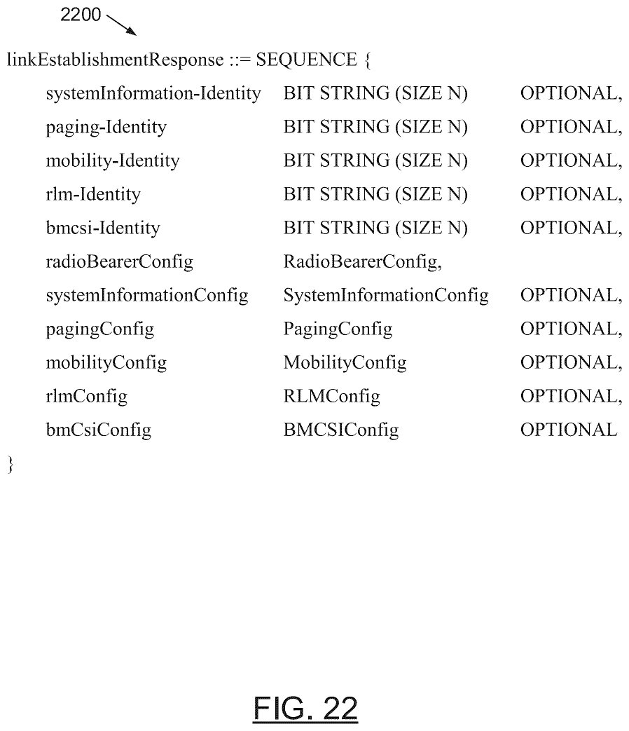

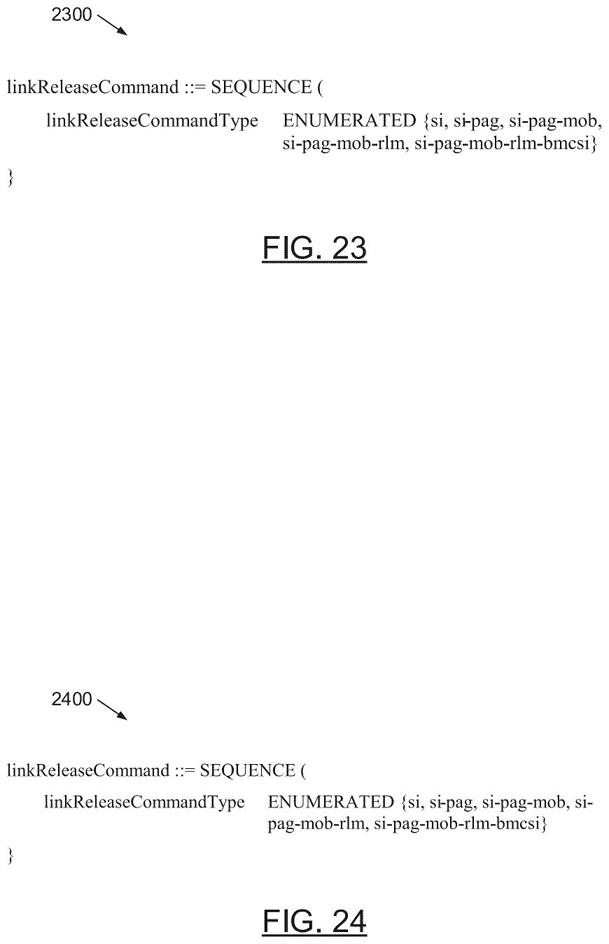

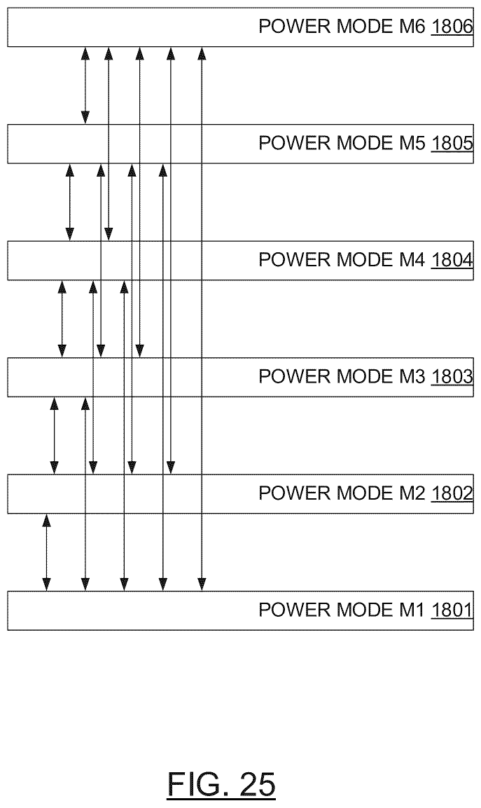

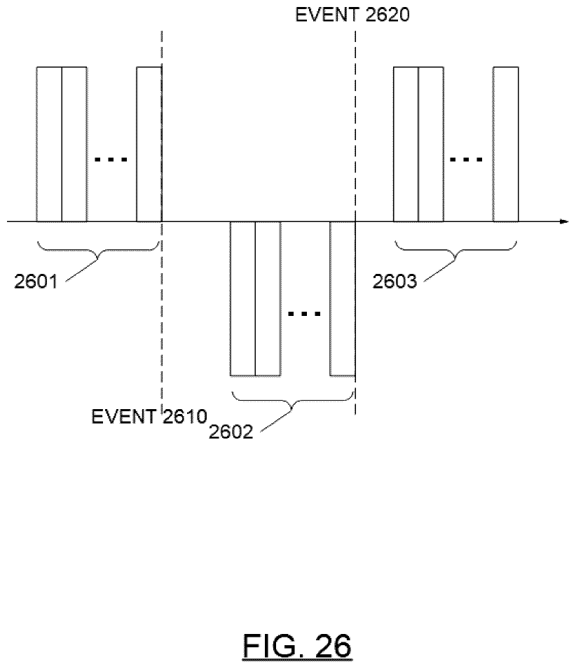

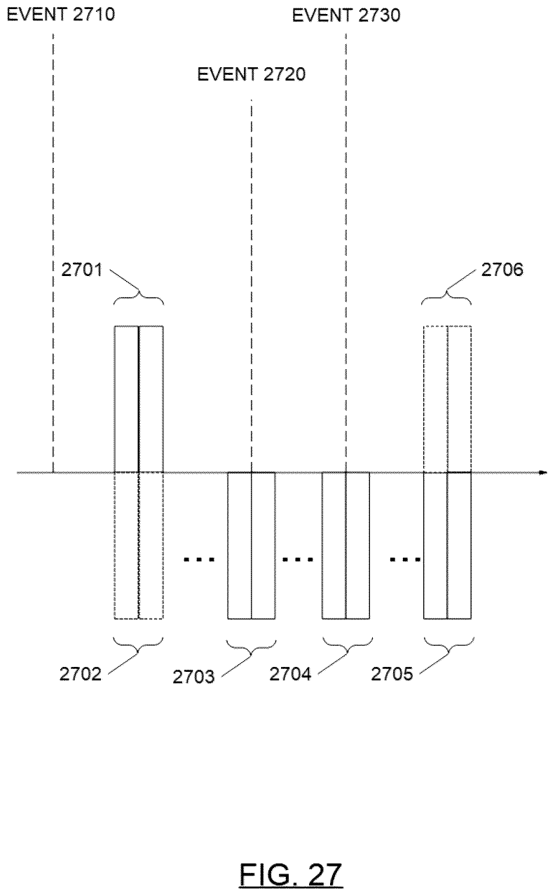

In a first example, a UE 110 (e.g., having an identity of 0x0010) is to transition from the idle mode 908 to the inactive mode 906. The UE 110 transmits, to a TRP 170/172, a Random Access preamble to, thereby, initiate a Random Access Channel procedure. The Random Access preamble is associated with a UE identity used for the Random Access Channel procedure. This UE identity may be based on the Random Access preamble index and/or on the time-frequency resources the Random Access preamble is transmitted on. In this example, the Random Access Channel procedure is associated with the RACH UE identity (e.g., equal to 0xabcd). The UE 110 waits to receive, from the TRP 170/172, a Random Access Response. The Random Access Response may be a PDCCH carrying a DCI format scrambled with the UE identity (oxabcd) that was associated with the Random Access preamble. The operation of “scrambling” the DCI format may be implemented in a variety of ways: as a first example, the bits of the DCI format are binary exclusive-or-ed (XOR-ed) with the bits of the UE identity (oxabcd); and, as a second example, the cyclic redundancy check (CRC) bits are XOR-ed with the bits of the UE identity (oxabcd). Upon receiving the Random Access Response, the UE 110 transmits a PUSCH transmission. FIG. 12 illustrates an example link establishment request 1220 that the UE 110 may include in the PUSCH transmission.

In a continuation of the first example, the TRP 170/172 may be configured to use a group-specific identity (e.g., equal to 0xFFFE) for system information messages. The TRP 170/172 may also be configured to use the same group-specific identity for paging information messages. Responsive to receiving the example link establishment request 1200 illustrated in FIG. 12, the TRP 170/172 may transmit a PDCCH carrying a DCI format scrambled with ue-Identity=0x0010. The PDCCH may schedule a future PDSCH transmission carrying link establishment response. The TRP 170/172 may then transmit the PDSCH transmission, as scheduled. FIG. 13 illustrates an example link establishment response 1300 that the TRP 170/172 may include in the PDSCH transmission.

Responsive to receiving the link establishment response 1300 from the TRP 170/172, the UE 110 may transition to the inactive mode 906. The UE 110 may then start monitoring SI messages and paging messages. The UE 110 may also perform positioning measurements. The UE 110 may, additionally, transmit a link establishment response completion message (not shown) to the TRP 170/172, thereby allowing the TRP 170/172 to register that the UE 110 has, indeed, received the link establishment response 1300 and has, responsively, transitioned to the inactive mode 906. The link establishment response 1300 may contain a higher-layer parameter, radioBearerConfig, which provides the UE 110 with all the necessary configuration parameters for establishing signaling and/or data radio bearers and for receiving and decoding subsequent higher-layer signaling messages (i.e., RRC messages). The link establishment response 1300 may also contain a higher-layer parameter, systemLinkConfig, which provides the UE 110 with all the necessary configuration parameters for monitoring and decoding System Information messages and/or Paging messages.

In a second example, a UE 110 (e.g., having an identity of 0x0037) is to transition from the idle mode 908 to the connected mode 910. The UE 110 transmits, to a TRP 170/172, a Random Access preamble to, thereby, initiate a Random Access Channel procedure. The UE 110 waits to receive, from the TRP 170/172, a Random Access Response. The Random Access Response may be a PDCCH carrying a DCI format scrambled with the UE identity (oxabcd) that was associated with the Random Access preamble based on the Random Access preamble index and/or on the time-frequency resources the Random Access preamble is transmitted on. In this example, the Random Access Channel procedure is associated with the RACH UE identity (e.g., equal to 0xabcd). Upon receiving the Random Access Response, the UE 110 transmits a PUSCH transmission. FIG. 14 illustrates an example link establishment request 1400 that the UE 110 may include in the PUSCH transmission.

In a continuation of the second example, the TRP 170/172 may be configured to use a group-specific identity (e.g., equal to 0xFFFF) for system information messages. The TRP 170/172 may also be configured to use a distinct group-specific identity (e.g., equal to 0xFFFE) for paging information messages. In operation, the TRP 170/172 may allocate, to the UE 110, a UE-specific phylayer-Identity (e.g., equal to 0x0249).

Responsive to receiving the example link establishment request 1400 illustrated in FIG. 14, the TRP 170/172 may transmit a PDCCH carrying a DCI format scrambled with ue-Identity=0x0037. The PDCCH may schedule a future PDSCH transmission carrying a link establishment response. The TRP 170/172 may then transmit the PDSCH transmission, as scheduled. FIG. 15 illustrates an example link establishment response 1500 that the TRP 170/172 may include in the PDSCH transmission.

Upon receiving the link establishment response 1500 from the TRP 170/172, the UE 110 transitions to the connected mode 910 and starts monitoring SI messages, paging messages and communication messages. The UE 110 also performs positioning measurements. The UE 110 may, additionally, transmit a link establishment response completion message (not shown) to the TRP 170/172, thereby allowing the TRP 170/172 to register that the UE 110 has, indeed, received the link establishment response 1500 and has, responsively, transitioned to the connected mode 910. The link establishment response 1500 may contain a higher-layer parameter, radioBearerConfig, which provides the UE 110 with all the necessary configuration parameters for receiving and decoding subsequent higher-layer signaling messages (i.e., RRC messages). The link establishment response 1500 may also contain a higher-layer parameter, systemLinkConfig, which provides the UE 110 with all the necessary configuration parameters for monitoring and decoding System Information messages and/or Paging messages. The link establishment response 1500 may also contain a higher-layer parameter, communicationLinkConfig, which provides the UE 110 with all the necessary configuration parameters for monitoring and decoding physical layer data transmissions carrying UE-specific data traffic.

In a third example, a UE 110 (e.g., having an identity of 0x1a79), is to transition from the inactive mode 906 to the connected mode 910. The UE 110 transmits, to a TRP 170/172, a Random Access preamble to, thereby, initiate a Random Access Channel procedure. The UE 110 waits to receive, from the TRP 170/172, a Random Access Response. The Random Access Response may be a PDCCH carrying a DCI format scrambled with the UE identity (oxabcd) that was associated with the Random Access preamble based on the Random Access preamble index and/or on the time-frequency resources the Random Access preamble is transmitted on. In this example, the Random Access Channel procedure is associated with the RACH UE identity (e.g., equal to 0xabcd). Upon receiving the Random Access Response, the UE 110 transmits a PUSCH transmission. FIG. 16 illustrates an example link establishment request 1600 that the UE 110 may include in the PUSCH transmission.

In a continuation of the third example, the TRP 170/172 may allocate, to the UE 110, a UE-specific phylayer-Identity (e.g., equal to 0x4f51). Responsive to receiving the example link establishment request 1600 illustrated in FIG. 16, the TRP 170/172 may transmit a PDCCH carrying a DCI format scrambled with ue-Identity=0x1a79. The PDCCH may schedule a future PDSCH transmission carrying link establishment response. The TRP 170/172 may then transmit the PDSCH transmission, as scheduled. FIG. 17 illustrates an example link establishment response 1700 that the TRP 170/172 may include in the PDSCH transmission.

Upon receiving the link establishment response 1700 from the TRP 170/172, the UE 110 transitions to the connected mode 910 and starts monitoring SI messages, paging messages and communication messages. The UE 110 also performs positioning measurements. The UE 110 may, additionally, transmit a link establishment response completion message (not shown) to the TRP 170/172, thereby allowing the TRP 170/172 to register that the UE 110 has, indeed, received the link establishment response 1700 and has, responsively, transitioned to the connected mode 910.

Aspects of the present application relate to definitions for UE power modes that may be associated with the positioning-based UE state machine 900 of FIG. 9. Indeed, six UE power modes may be defined, with each UE power mode defined based on one of six different levels of power consumption.

FIG. 18 illustrates an example of a framework 1800 of UE machine states based on six UE power modes.

The framework 1800 of UE machine states is illustrated in FIG. 18 to include six UE machine states: a first UE power mode (denoted as M1) 1801; a second UE power mode (denoted as M2) 1802; a third UE power mode (denoted as M3) 1803; a fourth UE power mode (denoted as M4) 1804; a fifth UE power mode (denoted as M5) 1805; and a sixth UE power mode (denoted as M6) 1806.

The first UE power mode 1801 may be considered to represent a lowest UE power consumption due to not relying on any beam sweeping. The UE 110 operates in the first UE power mode 1801 to maintain UE power consumption levels below a first threshold, P1. In the first UE power mode 1801, the UE 110 only measures non-terrestrial positioning RSs.

The second UE power mode 1802 is illustrated, in FIG. 18, as being lower-bounded by the first threshold, P1, and upper-bounded by a second threshold, P2. The second UE power mode 1802 is associated with the functions of positioning and SI acquisition. That is, in the second UE power mode 1802, the UE 110 only measures non-terrestrial positioning RSs and acquires SI (e.g., by monitoring a PDCCH carrying a DCI format scrambled with a UE identity associated with the function of SI acquisition).

The third UE power mode 1803 is illustrated, in FIG. 18, as being lower-bounded by the second threshold, P2, and upper-bounded by a third threshold, P3. The third UE power mode 1803 is associated with the functions of positioning, SI acquisition and paging. That is, in the third UE power mode 1803, the UE 110 only measures non-terrestrial positioning RSs, acquires SI (e.g., by monitoring a PDCCH carrying a DCI format scrambled with a UE identity associated with the function of SI acquisition) and monitors paging messages (e.g., by monitoring a PDCCH carrying a DCI format scrambled with a UE identity associated with the function of paging).

The fourth UE power mode 1804 is illustrated, in FIG. 18, as being lower-bounded by the third threshold, P3, and upper-bounded by a fourth threshold, P4. The fourth UE power mode 1804 is associated with the functions of positioning, SI acquisition, paging and mobility. That is, in the fourth UE power mode 1804, the UE 110 measures either terrestrial positioning RSs or non-terrestrial positioning RSs, acquires SI (e.g., by monitoring a PDCCH carrying a DCI format scrambled with a UE identity associated with the function of SI acquisition), monitors paging messages (e.g., by monitoring a PDCCH carrying a DCI format scrambled with a UE identity associated with the function of paging) and performs mobility measurements on mobility RSs transmitted from T-TRPs 170 or NT-TRPs 172.

The fifth UE power mode 1805 is illustrated, in FIG. 18, as being lower-bounded by the fourth threshold, P4, and upper-bounded by a fifth threshold, P5. The fifth UE power mode 1805 is associated with the functions of positioning, SI acquisition, paging, mobility and RLM. That is, in the fifth UE power mode 1805, the UE 110 measures either terrestrial positioning RSs or non-terrestrial positioning RSs, acquires SI (e.g., by monitoring a PDCCH carrying a DCI format scrambled with a UE identity associated with the function of SI acquisition), monitors paging messages (e.g., by monitoring a PDCCH carrying a DCI format scrambled with a UE identity associated with the function of paging), performs mobility measurements on mobility RSs transmitted from T-TRPs 170 or NT-TRPs 172 and monitors radio quality of a serving link (e.g., by measuring the RLM-RSs transmitted on the serving link).

The sixth UE power mode 1806 is illustrated, in FIG. 18, as being lower-bounded by the fifth threshold, P₅, and upper-bounded by a sixth threshold, P_{Max}. The sixth UE power mode 1806 is associated with the functions of positioning, SI acquisition, paging, mobility, RLM, BM and CSI. That is, in the sixth UE power mode 1806, the UE 110 measures either terrestrial positioning RSs or non-terrestrial positioning RSs, acquires SI (e.g., by monitoring a PDCCH carrying a DCI format scrambled with a UE identity associated with the function of SI acquisition), monitors paging messages (e.g., by monitoring a PDCCH carrying a DCI format scrambled with a UE identity associated with the function of paging), performs mobility measurements on mobility RSs transmitted from T-TRPs 170 or NT-TRPs 172, monitors radio quality of a serving link (e.g., by measuring the RLM-RSs transmitted on the serving link), performs beam management (BM) and carries out CSI measurement and reporting.

Each of the UE power modes 1801/1802/1803/1804/1805/1806 is associated with a set of functions. The function may be shown to entail: detecting, demodulating and measuring reference signals; and/or detecting, demodulating and decoding a physical layer channel. Every function involves some form of processing, e.g., in the form of executing, at a chip-level, instructions. The processing may be shown to result in power consumption at the chip-level, e.g., in the form of power dissipation caused by electrons moving between different layers of a transistor. It should be clear that the power consumption may be measured, e.g., in Joules/second. It follows that the execution of every function comes at a particular cost, where the cost may be expressed in terms of power consumption.

The power consumption thresholds for the different UE power modes 1801/1802/1803/1804/1805/1806 may be explicitly quantified in a standard specification. The power consumption thresholds for the different UE power modes 1801/1802/1803/1804/1805/1806 may be broadcast by a TRP 170/172 in a broadcast message. The power consumption thresholds for the different UE power modes 1801/1802/1803/1804/1805/1806 may be configured by a TRP 170/172 to a given UE 110 in a UE-specific manner. The UE-specific manner may, for example, be based on one or more capabilities associated with the given UE 110.

As a first example, the power consumption thresholds, P₁/P₂/P₃/P₄/P₅/P₆, for the different UE power modes 1801/1802/1803/1804/1805/1806 may be explicitly quantified in a standard specification.

As a second example, a set of default power consumption thresholds, P₁/P₂/P₃/P₄/P₅/P₆, for the different UE power modes 1801/1802/1803/1804/1805/1806 may be broadcast by a TRP 170/172 in a Physical Broadcast Channel (PBCH). The PBCH may carry a System Information Block (SIB) message. A SIB message template 1900 is illustrated in FIG. 19.

As a third example, a set of UE-specific power consumption thresholds, P₁/P₂/P₃/P₄/P₅/P₆, for the different UE power modes 1801/1802/1803/1804/1805/1806 may be configured, by a TRP 170/172, to a UE 110 in a higher-layer signaling message (e.g., an RRC signaling message). An example RRC signaling message template 2000 is illustrated in FIG. 20.

In all of the examples above, it may be assumed that values for the power consumption thresholds, P₁/P₂/P₃/P₄/P₅/P₆, may be expressed as integer numbers in the range {0, 1, . . . , 1000}, where the unit for each power consumption threshold value is expressed in milli-Joules per milli-second.

It may not be immediately evident that the UE power modes 1801/1802/1803/1804/1805/1806 illustrated in FIG. 18 might, in some way, correspond to the modes 906/908/910 illustrated in FIG. 9. However, it may be considered that the first UE power mode 1801 and the second UE power mode 1802 may be grouped within the idle mode 908. Similarly, the third UE power mode 1803 and the fourth UE power mode 1804 may be grouped within the inactive mode 906. It follows, then, that the fifth UE power mode 1805 and the sixth UE power mode 1806 may be grouped within the connected mode 910. It is notable, in this grouped context, that the UE 110 may transition between two adjacent UE power modes 1801/1802/1803/1804/1805/1806 without leaving one of the modes 906/908/910 illustrated in FIG. 9.

Aspects of the present application relate to transition mechanisms associated with a positioning-based UE state machine.

Six UE power modes 1801/1802/1803/1804/1805/1806 have been disclosed hereinbefore, based on six different ranges of power consumption. To allow a UE 110 to transition between two UE power modes among the UE power modes 1801/1802/1803/1804/1805/1806, one of many hand-shaking procedures may take place between the UE 110 and the TRP 170/172. According to one hand-shaking procedure, the UE 110 may transmit a link establishment request to the TRP 170/172. An example link establishment request template 2100 is illustrated in FIG. 21. Responsive to receiving a link establishment request, the TRP 170/172 may transmit a link establishment response. An example link establishment response template 2200 is illustrated in FIG. 22. The link establishment response may, as illustrated in FIG. 22, include information to allow the UE 110 to perform the functions associated with the state into which the UE 110 is to transition.

The TRP 170/172 may transmit a link release command to the UE 110. The link release command may be shown to allow the UE 110 to transition from one of the UE power modes 1802/1803/1804/1805/1806 to a lower one of the UE power modes 1801/1802/1803/1804/1805. An example link release command template 2300 is illustrated in FIG. 23. Notably, the example link release command template 2300 includes a linkReleaseCommandType field. The TRP 170/172 may use the linkReleaseCommandType field to indicate, to the UE 110, the functions that the UE 110 is to continue executing.

An alternative example link release command template 2400 is illustrated in FIG. 24. Notably, the alternative example link release command template 2400 includes a linkReleaseCommandType field. The TRP 170/172 may use the linkReleaseCommandType field to indicate, to the UE 110, the functions that the UE 110 is to stop executing.

FIG. 25 illustrates the UE power modes 1801/1802/1803/1804/1805/1806, of FIG. 18, in addition to arrows representative of various possible transitions between the UE power modes 1801/1802/1803/1804/1805/1806.

Aspects of the present application relate to updating positioning measurements based on the UE 110 transitioning between different UE power modes 1801/1802/1803/1804/1805/1806.

In view of the UE state machine of FIG. 18, defined based on six UE power modes 1801/1802/1803/1804/1805/1806, consider a scenario wherein a given UE 110 that is operating in the third UE power mode M3 1803 receives a link release command from a TRP 170/172, instructing the given UE 110 to switch to the second UE power mode M2 1802.

While the given UE 110 is operating in the third UE power mode M3 1803, it may be reasonably expected that the given UE 110 is carrying out positioning measurements based on terrestrial positioning RSs. Responsive to receiving a link release command from the TRP 170/172, with the linkReleaseCommandType field set to “pos-si”, the given UE 110 is expected to stop carrying out positioning measurements based on terrestrial positioning RSs. This change may be attributed to a relatively higher power consumption associated with carrying out positioning measurements based on terrestrial positioning RSs. Upon applying the link release command from the TRP 170/172, the given UE 110 may be expected to switch to the second UE power mode M2 1802. In association with switching to the second UE power mode M2 1802, the given UE 110 may autonomously switch positioning measurements to be based on non-terrestrial positioning RSs. As has been discussed hereinbefore, the power consumption associated with basing positioning measurements on non-terrestrial positioning RSs is expected to be lower than the power consumption associated with basing positioning measurements on terrestrial positioning RSs.

While the given UE 110 is operating in the second UE power mode M2 1802, the given UE 110 carries out positioning measurements based on non-terrestrial positioning RSs, as measurements based on non-terrestrial positioning RSs are the only form of measurement that can fit with the power consumption requirements associated with the second UE power mode M2 1802. At some stage, the given UE 110 may switch back to the third UE power mode M3 1803. To implement such a switch, the given UE 110 may transmit, to the TRP 170/172, a link establishment request, with the linkEstablishmentRequestType field set to si-pag (see FIG. 21). The TRP 170/172 responds, to the given UE 110, with a link establishment response (see FIG. 22) with appropriate values in the paging-Identity field and the pagingConfig field. Upon applying the link establishment response from the TRP 170/172, the given UE 110 may switch to the third UE power mode M3 1803. Further, the given UE 110 may autonomously switch positioning measurements back to being based on terrestrial positioning RSs responsive to determining that the given UE 110 is executing a service for which measurements of terrestrial positioning RSs are useful.

FIG. 26 illustrates an example of a timeline in which a UE 110 switches between positioning RSs transmitted by NT-TRPs 172 and positioning RSs transmitted by T-TRPs 170.

In the timeline illustrated in FIG. 26, the UE 110 initially operates in a first phase 2601, wherein the UE 110 performs positioning based upon terrestrial positioning RSs. Subsequent to a first event 2510, wherein the UE 110 transitions from the third UE power mode M3 1803 to the second UE power mode M2 1802, the UE 110 autonomously switches to a second phase 2602, wherein the UE 110 performs positioning based upon measuring non-terrestrial positioning RSs. Subsequent to a second event 2620, wherein the UE 110 transitions from the second UE power mode M2 1802 to the third UE power mode M3 1803, the UE 110 autonomously switches to a third phase 2603, wherein the UE 110 returns to performing positioning based upon measuring terrestrial positioning RSs.

Aspects of the present application relate to updating positioning measurements based on a UE 110 transitioning between different UE power modes and the UE 110 running the Positioning Accuracy Monitoring (PAM) function.

In view of the UE state machine of FIG. 18, defined based on six UE power modes 1801/1802/1803/1804/1805/1806, consider a scenario wherein a UE 110 has been configured with terrestrial positioning RSs and non-terrestrial positioning RSs and that the UE 110 has been configured to monitor Positioning Failure/Recovery instances. The monitoring may be based on detecting non-terrestrial positioning RSs, as part of the PAM function.

While the UE 110 is in a location that is indoors, the UE 110 may not be able to detect and measure non-terrestrial positioning RSs with sufficient quality for so-called high accuracy positioning. In such a situation, the UE 110 may autonomously initiate performing positioning measurements based on terrestrial positioning RSs.

Responsive to the UE 110 being moved to a new, outdoor location, the new location may be expected to result in an improvement in signal quality for non-terrestrial positioning RSs. The signal quality improvement may be seen to allow the UE 110 to detect and measure non-terrestrial positioning RSs with sufficient quality for high accuracy positioning. Upon switching to performing positioning measurements based on non-terrestrial positioning RSs, the UE 110 may be seen to achieve a lower power consumption, due to not using beam sweeping or otherwise having to perform Rx beamforming. The use of beam sweeping and Rx beamforming is known to be associated with detecting and measuring terrestrial positioning RSs. The UE 110 may proceed to monitor the non-terrestrial positioning RSs. During the monitoring, the UE 110 may detect a number, N, of Positioning Recovery Detection (PRD) instances on the non-terrestrial positioning RSs. Responsive to the UE 110 determining that N=N_{max_PRD}, where N_{max_PRD}≥1, the UE 110 may autonomously switch positioning measurements from terrestrial positioning RSs to non-terrestrial positioning RSs.

Responsive to the UE 110 being moved to an indoor location, the indoor location may be expected to result in a degradation in signal quality for non-terrestrial positioning RSs. The signal quality degradation may be seen to no longer allow the UE 110 to detect and measure non-terrestrial positioning RSs with sufficient quality for high accuracy positioning.

The UE 110 may proceed to monitor the non-terrestrial positioning RSs. During the monitoring, the UE 110 may detect a number, N, of Positioning Failure Detection (PFD) instances on the non-terrestrial positioning RSs. Responsive to the UE 110 determining that N=N_{max_PFD}, where N_{max_PFD}≥1, the UE 110 may autonomously switch positioning measurements from non-terrestrial positioning RSs to terrestrial positioning RSs.

FIG. 8 illustrates an example of a timeline in which a UE 110 switches between terrestrial positioning RSs and non-terrestrial positioning RSs and back again. In the timeline illustrated in FIG. 8, the UE 110 initially operates in the first phase 801, wherein the UE 110 performs positioning based upon terrestrial positioning RSs. Subsequent to the first event 810, wherein a change occurs in the radio environment as the UE 110 moves from an urban area to a rural area and the UE 110 determines that N=N_{max_PRD}, the UE 110 autonomously switches to the second phase 802, wherein the UE 110 performs positioning based upon measuring non-terrestrial positioning RSs. Subsequent to the second event 820, wherein a change occurs in the radio environment as the UE 110 moves from a rural area to an urban area and the UE 110 determines that N=N_{max_PFD}, the UE 110 autonomously switches to the third phase 803, wherein the UE 110 returns to performing positioning based upon measuring terrestrial positioning RSs.

Aspects of the present application relate to a solution to a known problem of RS multiplexing by establishing a prioritization to measure specific RSs depending on what is happening at the UE 110.

In view of the UE state machine of FIG. 18, defined based on six UE power modes 1801/1802/1803/1804/1805/1806, consider a scenario wherein a UE 110 has been configured for measuring terrestrial positioning RSs and for measuring non-terrestrial positioning RSs and that the UE 110 has been configured to monitor Positioning Failure/Recovery instances. The monitoring may be based on detecting non-terrestrial positioning RSs, as part of the PAM function.

While the UE 110 is operating in the sixth UE power mode M6 1806, the UE 110 may detect a beam failure. As a consequence of detecting beam failure, a beam failure recovery (BFR) timer may be caused to begin running and the UE 110 may initiate a BFR procedure. The BFR procedure may, for example, include the UE 110 scanning for candidate beams. The scanning for candidate beams may, for example, include the UE 110 measuring BFR reference signals (a BFR-RSs) on the candidate beams.

It may, sometimes, be the case that a positioning RS happens to be located on the same OFDM symbol as a BFR-RS. Upon detecting that the positioning RS is located on the same OFDM symbol as a BFR-RS of interest, the UE 110 may discontinue measuring the positioning RSs. The UE 110 may maintain the condition of not measuring the positioning RSs during the period wherein the BFR timer is running. The discontinuing of the measuring the positioning RSs may be understood to allow the UE 110 to effectively assign a higher priority to the BFR procedure and a lower priority to the task of maintaining positioning information.

Consider that, by the time the BFR timer is finished running, the UE 110 has recovered from the detected beam failure (i.e., the BFR procedure has completed). The UE 110 may then resume measuring the positioning RSs that the UE 110 has been configured to monitor. The resumption of measuring the positioning RSs may lead to the UE 110 detecting, based on the positioning RSs, a first PFD instance.

Upon detection of the first PFD instance, the UE 110 may start a PFD counter and continue to monitor the positioning RSs. Responsive to the UE 110 determining that the number, N, of PFD instances has reached a configured maximum, N_{max_PFD}, the UE 110 may commence prioritizing the measurement of positioning RSs over the measurement of BFR-RSs.

FIG. 27 illustrates an example of a timeline in which a UE 110 prioritizes RSs. In the timeline illustrated in FIG. 27, a first event 2710 is representative of the UE 110 detecting a beam failure. As discussed hereinbefore, responsive to detecting a beam failure, the UE 110 may cause a BFR timer to begin running and the UE 110 may initiate a BFR procedure. The example timeline of FIG. 27 illustrates a first phase 2701, in which the UE 110 is to measure BFR-RSs on candidate beams. The example timeline of FIG. 27 also illustrates a second phase 2702, in which the UE 110 is to measure positioning RSs on the same OFDM symbol as the BFR-RSs. In FIG. 27, the second phase 2702 is illustrated in dashed lines, because the UE 110 has prioritized measuring BFR-RSs over measuring positioning RSs. That is, the UE 110 does not measure positioning RSs in the second phase 2702.

In a third phase 2703, measuring positioning RSs proceeds normally. Even though the UE 110 has prioritized measuring BFR-RSs, there is no conflict, in the third phase 2703, between positioning RSs and BFR-RSs.

A second event 2720 is illustrated as occurring in the third phase 2703. The second event 2720 is representative of a first PFD instance at the UE 110. The UE 110 may determine that N<N_{max_PFD}, given that, because second event 2720 is representative of the first PFD instance, N=1.

In a fourth phase 2704, measuring positioning RSs proceeds normally. Even though the UE 110 has prioritized measuring BFR-RSs, in the fourth phase 2704, there is no conflict between positioning RSs and BFR-RSs.

A third event 2730 is illustrated as occurring in the fourth phase 2704. The third event 2730 is representative of a PFD instance at the UE 110. The UE 110 may determine, as a consequence of the PFD instance represented as the third event 2730, that N=N_{max_PFD}.

As discussed hereinbefore, responsive to detecting that N=N_{max_PFD}, the UE 110 may prioritize measuring positioning RSs over measuring BFR-RSs.

Notably, FIG. 27 illustrates a fifth phase 2705, in which positioning RSs are to be measured, and a sixth phase 2706, in which BFR-RSs are to be measured. The UE 110 is to measure positioning RSs on the same OFDM symbol as the BFR-RSs. In FIG. 27, the sixth phase 2706 is illustrated in dashed lines, because the UE 110 has prioritized measuring positioning over measuring BFR-RSs RSs. That is, the UE 110 does not measure BFR-RSs in the sixth phase 2706.

In some embodiments, the physical layer of the UE 110 may provide the requesting higher layer service (e.g., an application layer service) with reports from its Positioning measurements, such that the higher layer service is made aware of which Positioning reference signals (e.g., Terrestrial Positioning-RS or Non-Terrestrial Positioning-RS) the UE 110 has detected and demodulated in order to produce the corresponding reports. As an example, the reports provided by the UE 110 may contain one bit where “1” means that the corresponding Positioning report was generated from measurements on Terrestrial Positioning-RS and where “O” means that the corresponding Positioning report was generated from measurements on Non-Terrestrial Positioning-RS.

In some embodiments, one of the functions that the UE 110 may also perform is the function of Sensing, where the function of Sensing may be monostatic, bi-static or multi-static.

In some embodiments, the lowest power-consumption mode may be the mode where the UE performs Sensing, and correspondingly the UE may implement a UE state machine with a stand-alone Sensing state, while other states correspond to other UE power modes and these modes incorporate other functions in addition to Sensing.

In some embodiments, one of the functions that the UE 110 may also perform is the function of Communication, where the function of Communication includes the UE 110 transmitting and/or receiving a control channel (e.g., a PDCCH and/or a PUCCH) and/or a data channel (e.g., a PDSCH and/or a PUSCH). The control channel and/or the data channel may also include one or more reference signals for the purpose of assisting the UE 110 in demodulating the control channel and/or the data channel. The UE 110 detects and decodes the payload of the control channel and/or the data channel and, in the case of the data channel, the payload may be a UE-specific traffic data packet.

In some embodiments, the highest power-consumption mode may be the mode where the UE 110 performs Communication, Positioning and Sensing and, correspondingly, the UE 110 may implement a UE state machine with a corresponding UE power mode.

In some embodiments, the linkEstablishmentRequest message may, instead, be a power Mode Request message. The powerModeRequest message may contain a field named power ModeRequestType, which field may be expected to carry one value selected from an enumerated list that contains one or more values of power modes, such as {M1, M2, M3, M4, M5, M6} as shown in FIG. 18. Each of the values in the powerModeRequestType field refers to a UE power mode as defined in the UE power modes in FIG. 18.

In some embodiments, the linkEstablishmentResponse message may instead be a power ModeResponse message. The powerModeResponse message may contain respective higher-layer configuration parameters associated with the respective functions to be performed by the UE 110 for the power mode that the UE 110 requested in the power ModeRequestType field of the powerModeRequest message. Following reception and successful decoding of the power Mode Response by the UE 110, the UE 110 may transition into the power mode the UE 110 requested in the powerModeRequestType field of the power ModeRequest message.

In some embodiments, the linkReleaseCommand message may, instead, be a power ModeRelease message. The powerModeRelease message may contain a field named power Mode ReleaseType, which field may be expected to carry one value selected from an enumerated list that contains one or more values of power modes, such as {M1, M2, M3, M4, M5, M6} as shown in FIG. 18. Each of the values in the powerModeReleaseType field refers to a UE power mode as defined in the UE power modes in FIG. 18. Following reception and successful decoding of the powerModeRelease by the UE 110, the UE 110 may transition into the power mode indicated in the powerModeReleaseType field of the powerModeRelease message.

In some embodiments, the TRP 170/172 may send a powerModeFallback message to the UE 110. The powerModeFallback message may contain a field named powerMode, which field may be expected to carry one value selected from an enumerated list that contains one or more values of power modes, such as {M1, M2, M3, M4, M5, M6} as shown in FIG. 18.

In some embodiments, the DCI formats carried in a PDCCH may contain a one-bit field named powerModeFallback, which may be used by the TRP 170/172 to indicate, to the UE 110, that the UE 110 is to transition to its fallback power mode upon successfully decoding the DCI format. The fallback power mode may be, for example, the lowest power consumption mode.

In some embodiments, the TRP 170/172 may send a Medium Access Control-Control Element (MAC-CE) command to the UE 110, the MAC-CE command carrying a field named powerModeFallback, which is used by the TRP 170/172 to indicate, to the UE 110, that the UE 110 is to transition to its fallback power mode upon successfully decoding the MAC-CE command. There may, additionally, be a MAC-CE command application time before the UE 110 transitions to its fallback power mode. The fallback power mode may be, for example, the lowest power consumption mode. The purpose of the fallback power mode is for the UE 110 to have a default UE power mode to operate at in the event of unexpected problems, issues or circumstances.

In some embodiments, the functions of system information acquisition and paging may be combined. This combination may be implemented such that the DCI format carried in a PDCCH is scrambled with the systemInformation-Identity and the paging-Identity, where the scrambling is done by, for example, XORing the bits of the CRC appended to the DCI format with the bits of the systemInformation-Identity and the paging-Identity. The PDCCH carrying the DCI format scrambled with the systemInformation-Identity and the paging-Identity schedules a PDSCH carrying a packet containing a System Information Block message and a Paging message. More functions may be combined in the way described as above.

In some embodiments, there may be an explicit or implicit priority rule between the functions that are to be run when the UE 110 is operating at a given power mode. Taking UE power mode M2 as an example, the function of Positioning may have a higher priority than the function of System Information acquisition. The UE 110 may then spend a higher proportion (e.g., higher than 50%) of its power consumption budget for power mode M2 on the function of Positioning and a lower proportion (e.g., lower than 50%) of its power consumption budget for power mode M2 on the function of System Information acquisition. An example of an explicit priority rule is as follows: the TRP 170/172 transmits a SystemInformationBlock message carrying a parameter named powerConsumptionPriorityInfo carrying a field named priority which can take values in {pos; SI; Pag; Mob; RLM; BMCSI}. Another example of an explicit priority rule is as follows: the TRP 170/172 transmits a higher-layer signaling (e.g., RRC signaling) message carrying a parameter named powerConsumptionPriorityInfo carrying a field named priority which can take values in {pos; SI; Pag; Mob; RLM; BMCSI}. An example of an implicit priority rule is as follows: a function's priority is based on the number of UE power modes in which the function can be executed, where the higher numbers correspond to a higher priority. Taking the six UE power modes in FIG. 18 as an example, the Positioning function has a priority of six because the Positioning function can run in six UE power modes, whereas the Paging function has a priority of four because the Paging function can run in four UE power modes.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
transmitting, at a device operating in a first mode of a positioning-based device state machine, a request to transition to a second mode of the positioning-based device state machine; and
receiving, at the device, a response to the request, the response including information to allow the device to perform a function associated with the second mode.

2. The method of claim 1, wherein:
the first mode of the positioning-based device state machine is defined based on the device operating to maintain power consumption levels above a first lower threshold and below a first upper threshold, and
the second mode of the positioning-based device state machine is defined based on the device operating to maintain power consumption levels above a second lower threshold and below a second upper threshold.

3. The method of claim 1, wherein the first mode is an idle mode, and wherein the device operating in the idle mode detects and measures only positioning reference signals.

4. The method of claim 3, wherein the device detects and measures only non-terrestrial positioning reference signals.

5. The method of claim 1, wherein the function associated with the second mode comprises at least one of system information acquisition or monitoring for paging messages.

6. The method of claim 1, wherein the function associated with the second mode comprises detecting and measuring mobility reference signals.

7. The method of claim 1, wherein the function associated with the second mode comprises radio link monitoring, beam management, or channel state information determination.

8. An apparatus comprising:
at least one processor; and
a non-transitory computer readable storage medium storing programming, the programming including instructions that, when executed by the at least one processor, cause the apparatus to perform operations including:
transmitting, while operating in a first mode of a positioning-based device state machine, a request to transition to a second mode of the positioning-based device state machine; and
receiving a response to the request, the response including information to allow the apparatus to perform a function associated with the second mode.

9. The apparatus of claim 8, wherein:
the first mode of the positioning-based device state machine is defined based on the apparatus operating to maintain power consumption levels above a first lower threshold and below a first upper threshold, and
the second mode of the positioning-based device state machine is defined based on the apparatus operating to maintain power consumption levels above a second lower threshold and below a second upper threshold.

10. The apparatus of claim 8, wherein the first mode is an idle mode, and wherein the apparatus operating in the idle mode detects and measures only positioning reference signals.

11. The apparatus of claim 10, wherein the apparatus detects and measures only non-terrestrial positioning reference signals.

12. The apparatus of claim 8, wherein the function associated with the second mode comprises system information acquisition.

13. The apparatus of claim 8, wherein the function associated with the second mode comprises monitoring for paging messages or measuring mobility reference signals.

14. The apparatus of claim 8, wherein the function associated with the second mode comprises radio link monitoring, beam management, or channel state information determination.

15. A non-transitory computer readable medium having machine-executable instructions stored thereon, wherein the machine-executable instructions, when executed by at least one processing unit of an apparatus, cause the apparatus to perform operations, the operations comprising:
transmitting, while operating in a first mode of a positioning-based device state machine, a request to transition to a second mode of the positioning-based device state machine; and
receiving a response to the request, the response including information to allow the apparatus to perform a function associated with the second mode.

16. The non-transitory computer readable medium of claim 15, wherein:
the first mode of the positioning-based device state machine is defined based on the apparatus operating to maintain power consumption levels above a first lower threshold and below a first upper threshold, and
the second mode of the positioning-based device state machine is defined based on the apparatus operating to maintain power consumption levels above a second lower threshold and below a second upper threshold.

17. The non-transitory computer readable medium of claim 15, wherein the first mode is an idle mode, and wherein the apparatus operating in the idle mode detects and measures only positioning reference signals.

18. The non-transitory computer readable medium of claim 17, wherein the apparatus detects and measures only non-terrestrial positioning reference signals.

19. The non-transitory computer readable medium of claim 15, wherein the function associated with the second mode comprises system information acquisition or monitoring for paging messages.

20. The non-transitory computer readable medium of claim 15, wherein the function associated with the second mode comprises detecting and measuring mobility reference signals.
